(19) United States
(12) Patent Application Publication
(10) Pub. No.: US 2024/0056828 A1
(43) Pub. Date: Feb. 15, 2024

(54) CHANNEL STATE FEEDBACK FOR ENHANCED DYNAMIC SPECTRUM SHARING

(71) Applicant: Apple Inc., Cupertino, CA (US)

(72) Inventors: Ismael Gutierrez Gonzalez, San Jose, CA (US); Abhinav Gupta, Santa Clara, CA (US); Amir Farajidana, Sunnyvale, CA (US); Leilei Song, Sunnyvale, CA (US); Haitong Sun, Cupertino, CA (US); Weidong Yang, San Diego, CA (US)

(73) Assignee: Apple Inc., Cupertino, CA (US)

(21) Appl. No.: 18/260,007

(22) PCT Filed: Dec. 20, 2021
(86) PCT No.: PCT/US2021/064314

§ 371 Date: Jun. 29, 2023

Related U.S. Application Data
(60) Provisional application No. 63/134,886, filed on Jan. 7, 2021.

(51) Int. Cl. H04W 16/14; H04L 1/00; H04L 5/00; H04W 72/1273; H04B 7/06

(52) U.S. Cl. CPC H04W 16/14; H04L 1/0013; H04L 5/0051; H04W 72/1273; H04B 7/0626

(57) ABSTRACT

The present application relates to devices and components including apparatus, systems, and methods for configuring or utilizing rate matching patterns and interference measurements.

### CROSS REFERENCE TO RELATED APPLICATION

This application claims the benefit of U.S. Provisional Application No. 63/134,886, filed Jan. 7, 2021, which is hereby incorporated by reference in its entirety for all purposes.

### BACKGROUND

Dynamic spectrum sharing (DSS) has been introduced in Third Generation Partnership Project (3GPP) Fifth Generation (5G) New Radio (NR) to share spectrum between Long Term Evolution (LTE) and NR cells. The DSS framework allows the NR cell to rate match around LTE reference signals that would otherwise cause strong interference and compromise spectral efficiencies.

### BRIEF DESCRIPTION OF THE DRAWINGS

FIG. 1 illustrates a cellular system in accordance with some aspects.

FIG. 2 illustrates a time-frequency resource grid in accordance with some aspects.

FIG. 3 illustrates a signaling diagram in accordance with some aspects.

FIG. 4 illustrates another signaling diagram in accordance with some aspects.

FIG. 5 illustrates a channel state information report configuration in accordance with some aspects.

FIG. 6 illustrates an operational flow/algorithmic structure in accordance with some aspects.

FIG. 7 illustrates another operational flow/algorithmic structure in accordance with some aspects.

FIG. 8 illustrates another operational flow/algorithmic structure in accordance with some aspects.

FIG. 9 illustrates a user equipment in accordance with some aspects.

FIG. 10 illustrates a gNB in accordance with some aspects.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various aspects. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation.” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

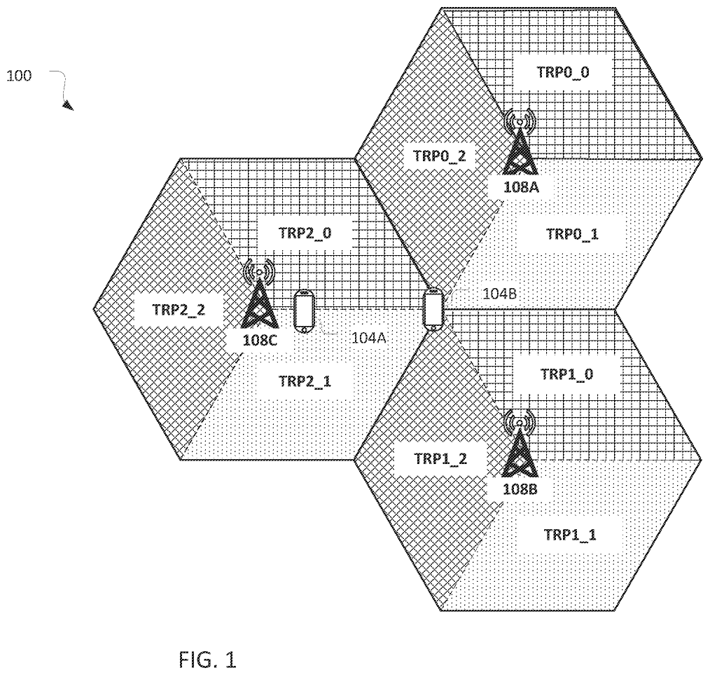

FIG. 1 illustrates a cellular system 100 in accordance with some aspects. The cellular system 100 may include a number of user equipments (UEs), such as UEs 104A and 104B, and base stations 108A, 108B, and 108C. The base stations 108 may provide a number of wireless serving cells, for example, 3GPP NR cells and LTE cells, to provide the UEs 104 with radio access.

The UEs 104 and the base stations 108 may communicate over air interfaces compatible with 3GPP technical specifications, such as those that define LTE or NR radio access technologies. The base stations 108 may include an evolved node B (eNB) coupled with an evolved packet core (EPC) network or a next-generation-radio access network (NG-RAN) node that is coupled with a 5G core network. An NG-RAN node may be either a gNB to provide an NR user plane and control plane protocol terminations toward the UE 104 or an ng-eNB to provide evolved universal terrestrial radio access (E-UTRA) user plane and control plane protocol terminations toward the UE 104.

Each base station 108 may include one or more transmit-receive points (TRPs) to provide radio resource control (RRC) connections for a particular sector that each cover 120°. As shown, base station 108A may include TRP0_0, TRP0_1, and TRP0_2; base station 108B may include TRP1_0, TRP1_1, and TRP1_2; and base station 108C may include TRP2_0, TRP2_1, and TRP2_2. Each sector may be considered its own serving cell. In some aspects, each sector may also include serving cells of different radio access technologies (RATs). For example, each sector may include an NR serving cell provided by an NR base station/TRPs (or, generally, gNB) and an LTE serving cell provided by LTE base station/TRPs (or, generally, eNB).

Performance of the cellular system may be driven by two key performance indicators (KPIs), signal-to-noise ratio (SNR) and signal-to-interference ratio (SIR), which may be combined into signal-to-interference-and-noise ratio (SINR). These KPIs may influence system performance differently based on a location of a UE in relation to a TRP with which it is connected. Consider, for example, that both UE 104A and UE 104B are connected with an NR cell provided by base station 108C. The UE 104A may experience near cell conditions in which both the signal level (from gNB) and the interference (from eNB) are high, while a noise level (which may be mainly dependent on thermal noise and other noise sources independent of the position of a UE within a cell) is low. Thus, SNR may be much larger than SIR. With near-cell conditions, the spectral efficiency of the NR cell may be limited by the interference from the LTE cell unless we avoid using resource elements where the interference is high. In this case, DSS may provide larger gains.

The UE 104B, being far away from the base station 108C, may experience far-cell conditions in which the signal level is low, in the range of interference and noise levels (for example, SNR˜SIR˜0 dB). In this case, all resource elements (REs) in a time-frequency resource grid may support a low spectral efficiency that is relatively similar across all REs.

As the near-cell conditions and the far-cell conditions illustrate, spectral efficiency may be highly dependent on the SIR.

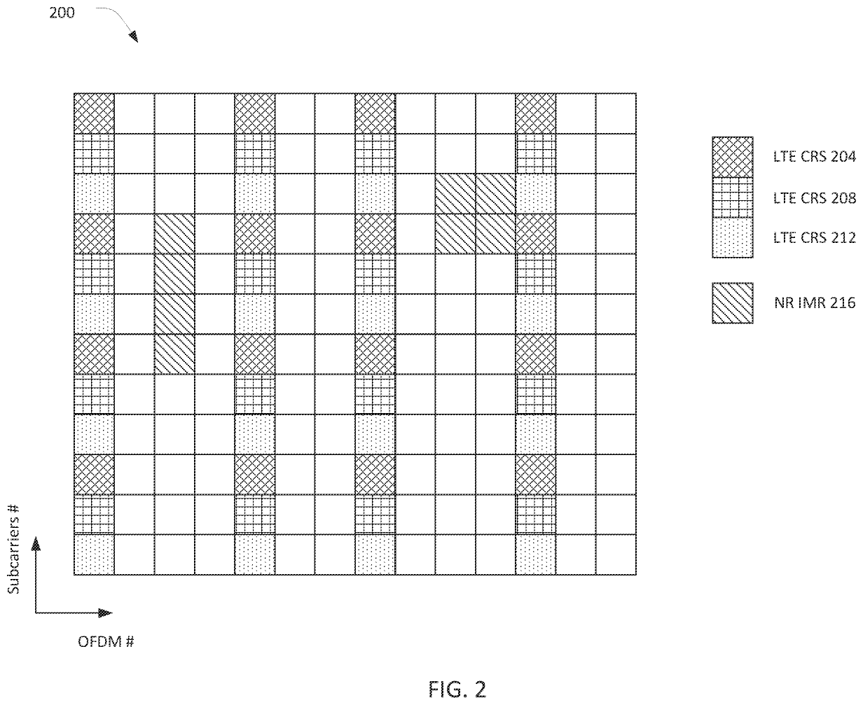

FIG. 2 illustrates a time-frequency resource grid 200 in accordance with some aspects. The resource grid 200 may be divided into a number of subcarriers in a frequency domain, and a number of orthogonal frequency division multiplexing (OFDM) symbols in a time domain. As shown, the resource grid 200 includes 12 subcarriers and 14 OFDM symbols; however, this is not restrictive of other aspects. An RE may be defined as one subcarrier and one OFDM symbol.

The resource grid 200 illustrates patterns of cell-specific reference signals (CRSs) transmitted in LTE serving cells. For example, the resource grid 200 illustrates LTE CRS 204 transmitted in sectors associated with TRP0_2. TRP1_2, and TRP2_2; LTE CRS 208 transmitted in sectors associated with TRP0_0, TRP1_0, and TRP2_0; and LTE CRS 212 transmitted in sectors associated with TRP0_1, TRP1_1, and TRP2_1.

In order to estimate the supported spectral efficiency, a gNB may configure channel state reporting to a UE by configuring interference measurement resources (IMRs). Resource grid 200 illustrates NR IMR 216 with a 2×2 RE shape and a 4×1 RE shape in the frequency/time direction. These NR IMR patterns may not allow for accurate estimation of interference caused by a neighbor LTE cell. This may prevent the determination of which REs should be rate matched around through DSS.

Desired DSS rate matching may be a function of a UE's capability to accurately and precisely identify and, if possible, mitigate LTE interference by using, for example, interference cancellation. Desired DSS rate matching may also be a function of a gNB's ability to set the appropriate rate matching pattern that allows the UE to skip REs that are the subject of LTE interference that cannot be effectively mitigated or canceled at the UE. Thus, aspects describe IMR and rate matching pattern configuration and selection, as well as related signaling, to improve DSS operation and enhance overall system performance.

In some aspects, a number of new configurations may be defined to facilitate DSS operation. For example, aspects may define new CSI IMRs, CSI resource configurations, and report quantities.

The new CSI IMRs may be configured with a pattern that matches a pattern of potentially interfering LTE reference signals. For example, a CSI IMR pattern may correspond to an LTE CRS by having a frequency spacing of three, six, or a multiple thereof to allow for down sampling on the UE side. In addition, the network may provide the UE with additional information to reconstruct an LTE reference signal. This may enable the UE to perform interference cancellation if the UE supports such operation. The additional information may include, but is not limited to, a cell ID, an initialization seed for a scrambling sequence, etc.

The new CSI resource configurations (for example, CSI-ResourceConfig) may allow the network to map IMRs from different potential interfering cells and map them to a report configuration. As will be described, this may allow the base stations 108 flexibility in selecting IMR patterns that most closely match real-time interference that may be experienced by a UE 104 in a given position within a cell and proximity to neighbor cells.

The new report quantity may include a layer 1 (L1) metric that contains a reference signal receive power (RSRP) corresponding to configured neighbor cells. In some aspects, the L1 metric may be referred to as an L1 neighbor cell (NC) RSRP (L1-nc-RSRP).

The UEs 104 may use the new configurations to measure interference coming from different interfering LTE cells and provide an indication to the network of the energy from the neighbor cells. The gNB may use the reported information, for example, the L1-nc-RSRP, to configure the rate matching for the DSS. In this manner, a clear view of the interference levels may be provided to a serving gNB without requiring a UE to perform an inter-RAT measurement using an LTE modem. This may allow single-mode 5G modems to still perform well using DSS when camped on NR cells that share spectrum with LTE cells.

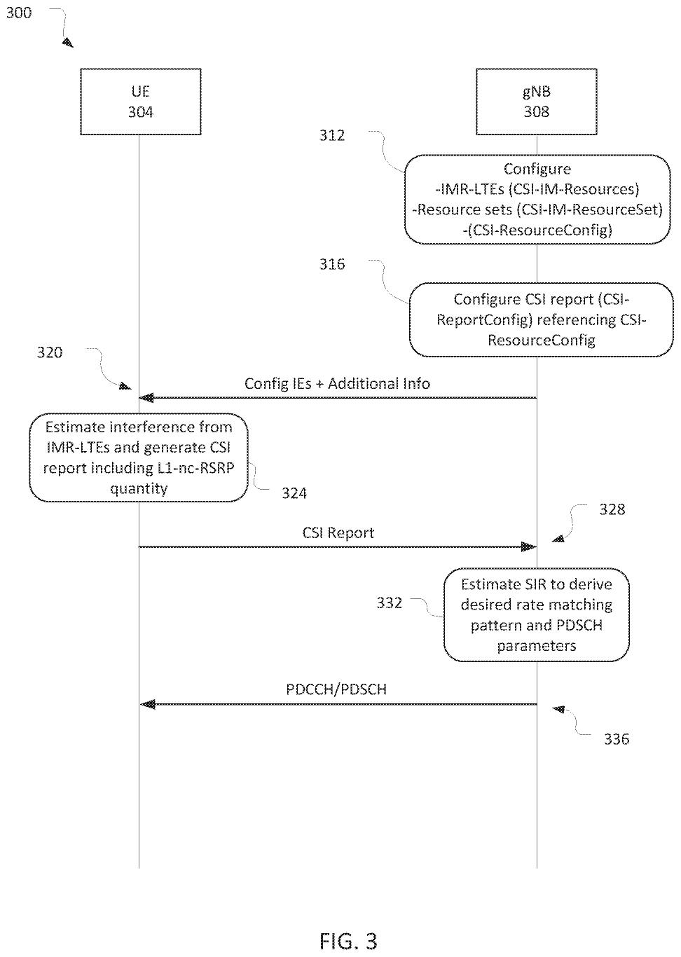

FIG. 3 illustrates a signaling diagram 300 in accordance with some aspects. The signaling diagram 300 describes operations and signaling among a UE 304 and a gNB 308. The UE 304 may be similar to, and substantially interchangeable with, UEs 104. The gNB 308 may be similar to, and substantially interchangeable with, base stations 108.

At 312, the gNB 308 may configure a number of information elements (IEs) to facilitate measurement of IMRs that correspond to LTE reference signals.

In some aspects, the gNB 308 may configure a plurality of IMR LTEs. An IMR LTE may include REs that map to a particular LTE reference signal. For example, in some aspects IMR LTEs may be configured for one or more of the always-on signals of an LTE cell including, for example, CRS, primary synchronization signal (PSS)/secondary synchronization signal (SSS) or channel state information-reference signal (CSI-RS).

An IMR LTE may be configured by a CSI IMR (CSI-IA-Resource) information element (IE) as follows.

| | |
|---|---|
| CSI-IM-Resource ::= | SEQUENCE { |
| csi-IM-ResourceId | , |
| csi-IM-ResourceElementPattern | CHOICE { |
| pattern0 | SEQUENCE { |
| subcarrierLocation-p0 | ENUMERATED { s0, s2, s4, s6, s8, s10 }, |
| symbolLocation-p0 | INTEGER (0..12) |
| }, | |
| pattern1 | SEQUENCE { |
| subcarrierLocation-pl | ENUMERATED { s0, s4, s8 }, |
| symbolLocation-pl | INTEGER (0..13) |
| }, | |
| pattern2 | SEQUENCE { |
| subcarrierLocation-p2 | ENUMERATED {...}, |
| symbolLocation-p2 | INTEGER (...) |
| density | |
| }, | |
| ... | |
| pattern_n | SEQUENCE { |
| subcarrierLocation-pn | ENUMERATED {...}, |
| symbolLocation-pn | INTEGER (...) |
| density | |
| }, | |
| }, | |

| | |
|---|---|
| } | OPTIONAL, --Need M |

| | | |
|---|---|---|
| freqBand | CSI-FrequencyOccupation | OPTIONAL, -- |
| Need M | | |
| periodicity AndOffset | CSI-ResourcePeriodicityAndOffset | OPTIONAL, |
| --Cond PeriodicOrSemiPersistent | | |
| ... | | |
| } | | |

The CSI-IM-Resource IE may include a CSI-IM-resource identifier (ID) field, a resource element pattern with corresponding parameters, a frequency band to indicate a frequency occupancy of the CSI-IM, or a periodicity and offset field to indicate a periodicity and slot offset for periodic or semi-persistent CSI-IM. The pattern fields may include a respective subcarrier and symbols locations for the respective patterns. In general, pattern 0 may correspond to the 2×2 RE pattern, pattern 1 may correspond to the 4×1 RE pattern, and patterns 2-n may respectively correspond to patterns of LTE reference signals. In addition to subcarrier location and symbol location, patterns 2-n may include a density field to allow for downsampling across slots.

In some aspects, another pattern may be added with reference to a RateMatchPatternLTE-CRS IE, which may be similar to that described below. Given that the RateMatchPatternLTE-CRS IE already provides a center frequency (for example, a DC carrier), a bandwidth, and a periodicity, it may be unnecessary to include parameters such the frequency band or periodicity and offset parameters shown in the IE above.

The gNB 308 may configure resource sets with each resource set having a group of IMR-LTEs that may be associated with a same cell. For example, a first LTE cell may include three LTE reference signals, LTE1, LTE2, and LTE3, for which interference measurements for an NR cell are desired. The gNB 308 may then configure a CSI IMR set (using a CSI-IM-ResourceSet IE) that includes references (for example, three CSI-IM-ResourceIDs) to CSI IMRs that correspond to those three LTE reference signals. The CSI-IM-ResourceSet IE may also include set-specific parameters.

The gNB 308 may further configure a CSI-Resource configuration (using a CSI-ResourceConfig IE) to define a group of CSI IMR sets. The CSI-ResourceConfig IE may include a list of CSI IMR sets (CSI-IM-ResourccSetList) of relevant resource sets.

At 316, the gNB 308 may configure a CSI report (using a CSI-ReportConfig IE) to instruct the UE 304 to measure a specific selection of REs that may be interfered by LTE reference signals. The CSI-ReportConfigIE may be used to configure a periodic/semi-persistent/aperiodic report that references an identity of a CSI-ResourceConfig that provides configuration for desired IMR LTEs. In some instances, the report may include a combination of both periodic resources (for example, IMR to measure LTE interference) with periodic, semi-persistent, or aperiodic resources from NR. For example, the report may include a periodic resource (for example, IMR) with an aperiodic resource (for example, channel measurement resource (CMR)).

With reference to the layout of cellular system 100, the gNB 308 may determine that the UE 304, while connected to an NR cell provided by TRP2_0, is proximate to LTE cells corresponding to TR0_2 as well. Therefore, the gNB 308 may configure a CSI report for CSI-ResourceConfig that includes a first CSI IMR set corresponding to TRP 2_0 (including, for example, IMR LTEs corresponding to LTE CRS 208) and a second CSI IMR set corresponding to TR0_2 (including, for example, IMR LTEs corresponding to LTE CRS 204). In this case, it may be that the UE 304 is not near the sector provided by TRP2_1, so LTE CRS 212 may not be of concern.

The CSI-ReportConfigIE may include a report quantity that identifies a CSI-related quantity to report. In some aspects, a new report quantity may be used to instruct the UE 304 to perform layer 1 RSRP measurements on the configured neighbor cells. This report quantity may be referred to as an L1-nc-RSRP.

Except as otherwise noted herein, the parameters of the CSI-IM-Resource. CSI-IM-ResourceSet, CSI-ResourceConfig, and CSI-ReportConfig IEs may be similar to those described in section 6.3.2 of 3GPP TS 38.331 v16.2.0 (2020-09).

At 320, the gNB 308 may transmit the configuration IEs to the UE 304 to effectuate the configurations. It may be noted that the configuration IEs may be transmitted to the UE 304 in a number of different configuration messages and at different times. In some aspects, the configuration IEs may be transmitted by RRC signaling and may be part of radio resource management (RRM) procedures.

In some aspects, the gNB 308 may, at 320, further provide the UE 304 with additional side information that the UE 304 may use to reconstruct the interfering signal. For example, the additional side information may allow the UE 304 to estimate a neighbor cell channel/time/frequency offset sufficiently to reconstruct the LTE reference signal and reduce associated interference with desired NR signals. By providing this additional information, the UE 304 may not need to blindly detect the broadcast system information from the LTE cell directly, which would require additional time and platform resources (for example, an LTE modem).

At 324, the UE 304 may perform L1 RSRP measurements on the IMR LTEs as configured by the CSI-ReportConfig IE. In this manner, the UE 304 may estimate interference caused by the corresponding LTE reference signals. If the UE 304 is able to cancel or mitigate the interference on any of the IMR LTEs, the L1 RSRP measurements may reflect such an interference reduction.

At 328, the UE 304 may transmit the CSI report including the L1 RSRP measurements as configured by the CSI-ReportConfig to the gNB 308.

At 332, the gNB may estimate an SIR to derive a desired rate matching pattern and PDSCH parameters based on the L1 RSRP measurements received from the UE 304. In this manner, the gNB 308 may have visibility as to the resource elements that are truly compromised by LTE reference signals in neighbor cells. Thus, the gNB 308 may select a rate matching pattern that avoids, in part or in full, the compromised resource elements.

At 336, the gNB 308 may transmit a PDCCH/PDSCH. The PDCCH may provide an indication of the selected rate matching pattern (or patterns) and may schedule the PDSCH. Alternatively, the selected rate matching pattern or patterns may be provided independently from the scheduling PDCCH.

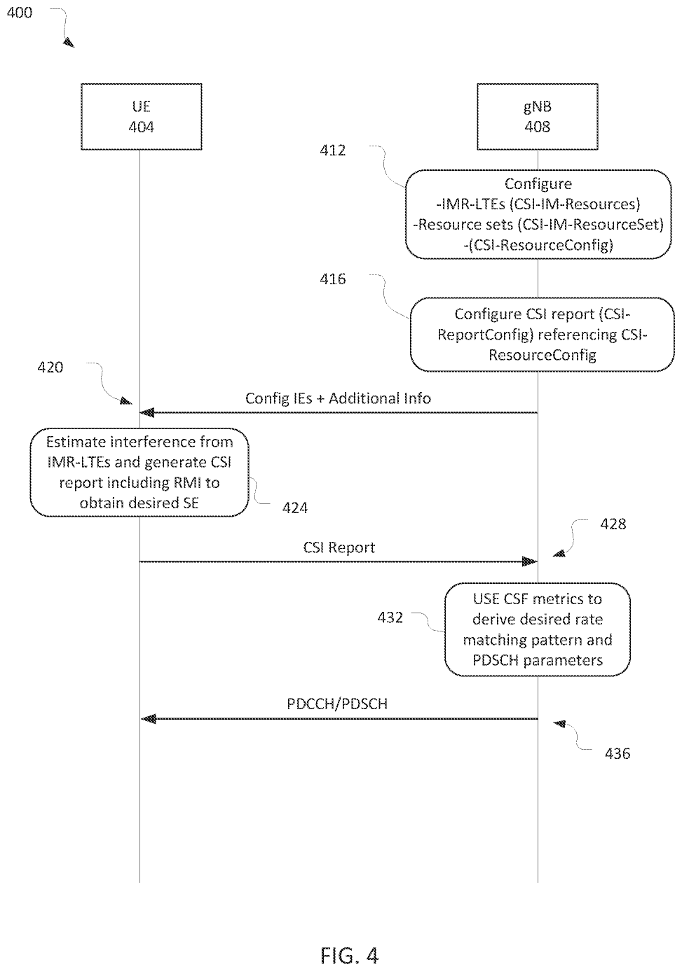

FIG. 4 illustrates a signaling diagram 400 in accordance with some aspects. The signaling diagram 400 describes operations and signaling among a UE 404 and a gNB 408. The UE 404 may be similar to, and substantially interchangeable with, UEs 104. The gNB 408 may be similar to, and substantially interchangeable with, base stations 108.

The gNB 408 may configure resources at 412 and the report at 416, and send the configurations to the UE 404 at 420, in a manner similar to that described above with respect to FIG. 3. However, in this aspect, the CSI-ReportConfig IE may include a new report quantity to instruct the UE 404 to provide a rate matching indicator (RMI). For example, the report quantity may be a rmi-cri-ri-li-pmi-cqi report quantity that, in addition to requesting RMI, may request one more additional channel-state feedback (CSF) metrics such as, but not limited to, CSI-RS resource indicator (CRI), rank indicator (RI), layer indicator (LI), precoding matrix indicator (PMI), or a channel quality information (CQI).

At 424 the UE may measure the IMR LTEs to estimate interference from the different interfering LTE cells (and cancelling or mitigating the interference if possible) and select a preferred rate matching configuration that, for example, obtains the desired spectral efficiency. The preferred rate matching configuration may be indicated by an RMI, which may be a bit mask that indicates the resource elements that the UE 404 recommends a subsequent PDSCH be rate matched.

The other CSF metrics may be determined based on an assumption that the preferred rate matching configuration is selected.

At 428, the UE 404 may transmit the CSI report to the gNB 408. The gNB 408 may, at 432, use the reported CSF metrics, including the RMI, to derive a rate matching pattern and the rest of the PDSCH parameters. In some aspects, the gNB 408 may use the RMI information to dynamically configure the zero-power reference signals so that the resource elements are interfered by LTE reference signals, and whose interference cannot be sufficiently reduced, and/or are not used for the schedule PDSCH. In some aspects, the gNB 408 may use media access control (MAC) or downlink control information (DCI)-based signaling to dynamically configure the zero-power reference signals.

Given that the UE 404 has visibility into how the interference from different LTE cells may combine at its location, and has knowledge of its expected demodulation performance, the UE 404 providing a preferred rate matching configuration may increase spectral efficiencies provided by DSS.

In some aspects, the UE 104 may determine the preferred rate matching configuration (for example, RMI) as follows.

In general, the network may configure multiple resources and the UE 104 may build multiple hypotheses to estimate which combination of interference sources and rate matching patterns leads to a highest throughput.

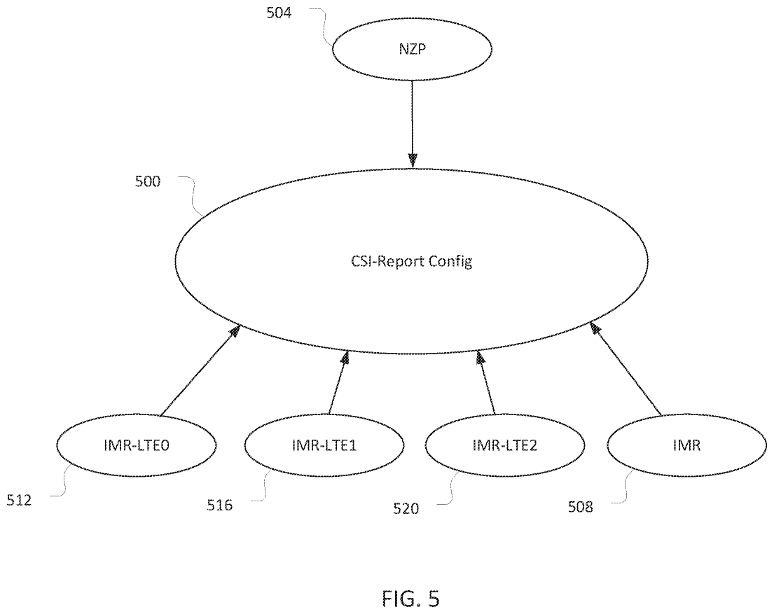

FIG. 5 illustrate a CSI-Report Config 500 in accordance with some aspects. In this aspect, the network configures the CSI-Report config 500 with one desired signal (nonzero power (NZP) 504), one IMR (IMR 508), and three IMR-LTE resources (IMR-LTE0 512, IMR-LTE1 516, and IMR-LTE2 520). The following hypotheses may be estimated.

In a first hypothesis, rmi=0. For example, none of the interfering cells are rate matched. In this hypothesis spectral efficiency may be a function of four ratios: NZP/LTE0; NZP/LTE1; NZP/LTE2; and NZP/IMR. The first three of these ratios may be considered SIRs, while the last of these ratios may be considered SNR as it may account for general noise reflected by the IMR.

In a second hypothesis, rmi=1. For example, only LTE0 is rate matched. In this hypothesis, spectral efficiency may be a function of three ratios: NZP/LTE1, NZP/LTE2, and NZP/IMR. Because the PDSCH will be rate matched around the resource elements that would experience interference from LTE0, it is not necessary to consider NZP/LTE0.

In a third hypothesis, rmi=2. For example, only LTE1 is rate matched. In this hypothesis, spectral efficiency may be a function of three ratios: NZP/LTE0; NZP/LTE2; and NZP/IMR. Because the PDSCH will be rate matched around the resource elements that would experience interference from LTE1, it is not necessary to consider NZP/LTE1.

In a third hypothesis, rmi=3. For example, LTE0 and LTE1 are rate matched. In this hypothesis, spectral efficiency may be a function of two ratios: NZP/LTE2 and NZP/IMR. Because the PDSCH will be rate matched around the resource elements that would experience interference from LTE0 and LTE 1, it is not necessary to consider NZP/LTE0 or NZP/LTE1.

Additional hypotheses may also be considered.

In some aspects, the spectral efficiency may be estimated using a weighted metric combining the different SIR estimates knowing a number of resource elements that are skipped for rate matching. The spectral efficiency for a given rmi may be provided as follows:

SE(rmi)=w₀(rmi)×SE(NZP,IMR LTE0)×¬(bitand(rmi,001_{b})>0)+w₁(rmi)×SE(NZP,IMR LTE1)×¬(bitand(rmi,010_{b})>0)+w₂(rmi)×SE(NZP,IMR LTE2)×¬(bitand(rmi,100b)>0)+w₃(rmi)×SE(NZP,IMR):

with sum(wₙ)=I and ¬x represents a logical negation of x.

In this equation, the wᵢ(rmi) represents a percentage of the total REs having interference estimated by associated IMRs. For example, w₀(rmi) is the percentage of the total available REs that have interference estimated from IMR LTE0 (interference caused by LTE0). The SE(NZP,IMR . . . ) component represents the spectral efficiency as a function of the SIR ratio. This may be computed based on an RE-by-RE basis.

The ¬bitand(rmi, . . . ) component accounts for the resource elements that would be excluded from consideration for a given RMI. For example, for rmi=2, the ¬bitand(rmi, . . . ) expressions of the first line and third line would go to 1, while the ¬bitand(rmi, . . . ) expression of the second line would go to 0, which effectively removes the line that considers LTE1 interference from the SE calculation given that the signal would be rate matched around LTE1 when rmi=2.

The UE 304 may then select the RMI that provides the relatively highest spectral efficiency, for example, maxSE(rmi)ᵣₘᵢ.

3GPP Releases 15 and 16 provide up to six LTE CRS patterns for rate matching a PDSCH of an NR cell around an LTE CRS at the RE level. These LTE CRS patterns are configured per NR component carrier (CC) due to a maximum bandwidth difference between LTE and NR as well as the multi-TRP operation (for example, three per TRP to account for a maximum 100 physical resource blocks (PRBs) in LTE, while maximum 275 PRB in NR and maximum two TRPs).

As described above, in order to account for a plurality of neighbor LTE cells, and not just the one LTE cell that overlaps in coverage with an NR cell, six rate matching patterns may not provide sufficient flexibility. Thus, in some aspects, the gNB may be allowed to configure more than six LTE CRS patterns for rate matching per NR serving cell. In some aspects, 18 rate matching patterns may be configured; however, other aspects may include other numbers. Providing the additional rate matching patterns may allow the gNB to more effectively rate match around LTE reference signals transmitted in neighbor cells. This may be especially beneficial for UEs that are located at a cell boundary.

In some aspects, the gNB may use a rate matching pattern LTE-CRS (RateMatchPatternLTE-CRS) IE to configure patterns to rate match around an LTE CRS. This IE, which may be transmitted to the UE by RRC signaling, may include a center frequency of an LTE carrier; a bandwidth of the LTE carrier in number of PRBs; an LTE multicast-broadcast single-frequency network (MBSFN) subframe configuration; a number of LTE CRS antenna ports to rate match around, and a shifting value v-shift in LTE to rate match around the LTE CRS.

A rateRateMatchPatternLTE-CRS IE may be as follows:

```
RateMatchPatternLTE-CRS ::= SEQUENCE {
  carrierFreqDL INTEGER (0..16383),
  carrierBandwidthDL ENUMERATED {n6, n15, n25, n50,
n75, n100, spare2, spare 1},
  mbsfn-SubframeConfigList EUTRA-MBSFN-SubframeConfigList
OPTIONAL, --Need M
  nrofCRS-Ports ENUMERATED {n1, n2, n4},
  v-Shift ENUMERATED {n0, n1, n2, n3, n4, n5}
}
```

Except as noted herein, the rateRateMatchPatternLTE-CRS IE may be similar to that described in section 6.3.2 of 3GPP TS 38.331.

The DC carrier (for example, subcarrier 0) may be handled differently in LTE and NR. In LTE, the DL DC carrier is punctured, while it is treated as a normal subcarrier in NR. Therefore, when we overlay LTE and NR resource grids, from the NR perspective, the LTE CRS occurrence may jump by one subcarrier when it starts to cross the DC subcarrier and the LTE CRS may not have uniform spacing (for example, every three REs) around the LTE DC subcarrier. For CRS, the DC (or center of the LTE CC) is configured as described above. So there is no ambiguity for the UE. Thus, there may be two options for how to use CSI-IM to configure/match the LTE CRS pattern. In a first option, the gNB may split one LTE CRS into two CSI-IM resources, for example, one to the left of the LTE DC and one to the right of the LTE DC. In a second option, the LTE CRS pattern itself may be used to configure the IMR RS pattern. For example, the LTE CRS pattern may be included as a pattern in the CSI-IM-Resource element. The LTE CRS pattern may be included by being directly incorporated into the CSI-IM resource element or by being referenced using, for example, an index of the LTE CRS pattern.

In some aspects, one or more of the additional rate matching patterns may include the DC carrier. For example, the rate matching patterns may allow for transmission of resource elements using subcarrier 0, which was not available for data transmission in LTE as noted above.

In some aspects, based on the UE-enhanced CSI reporting, the gNB may dynamically acquire the knowledge of whether, or to what level, the UE can perform interference cancellation with respect to an LTE CRS. As a result, the gNB may dynamically activate or deactivate one or more RateMatchPatternLTE-CRS. In some aspects, the activation/deactivation may be achieved by the gNB transmitting control signals through MAC-CE or DCI.

For example, consider that the gNB initially configures ten RateMatchPatternLTE-CRSs for a given NR serving cell. As mentioned above, this may be done by transmitting one or more IEs through RRC signals to the UE. At a later time, the UE may transmit a CSI report to the gNB with L1-nc-RSRP values that provide an indication of (or a basis for determining) the resource elements upon which interference may not be sufficiently mitigated. The gNB may then determine which combination of the ten configured RateMatchPatternLTE-CRSs provide the desired spectral efficiency. If it is determined that the first three patterns (for example, the three with lowest ID numbers) should be activated and the last seven patterns should be deactivated, the gNB may send an appropriate control signal through, for example, a bitmap of {1 1 0 0 0 0 0 0 0}. The UE may determine the resource elements around which a PDSCH is rate matched based on the set of activated RateMatchPatternLTE-CRS. The gNB will not rate match the PDSCH around resource elements indicated by the patterns of the deactivated RateMatchPatternLTE-CRS. In some aspects, the UE may use the activated/deactivated RateMatchPatternLTE-CRS to assist performance of the LTE CRS cancellation.

An NR PDCCH is configured by a control resource set (CORESET) that sets the frequency and number of symbols for the control channel. A search space associated with the CORESET configures the time of the control channel, for example, periodicity, offset, etc. In 3GPP Release 15 and 16, the NR PDCCH is rate matched around the LTE CRS at a symbol level. For example, the NR PDCCH cannot be configured in a symbol that overlaps in time with a symbol carrying the LTE CRS.

The LTE CRS is a dense signal that includes four symbols per slot for one or two-port CRS and six symbols per slot for four-port CRS. This significantly reduces the number of symbols available for an NR CORESET.

In some aspects, the gNB may be allowed to configure an NR PDCCH in a symbol that collides with a symbol that includes an LTE CRS. This may be restricted to situations in which a UE is capable of receiving an NR PDCCH in the presence of an interfering LTE CRS. For example, if the UE is able to cancel or sufficiently mitigate interference caused by an LTE CRS, which may be enabled by the gNB providing additional information as described above, it may be able to properly receive an NR PDCCH that would otherwise collide with an LTE CRS. In some aspects, the UE may provide an indication of its capability to receive such an NR PDCCH, and the gNB may only schedule an NR PDCCH in a symbol that overlaps with a LTE CRS symbol for the UEs that have signaled their capability.

In some aspects, the gNB may dynamically indicate whether an NR PDCCH may collide with an LTE CRS (for example, be scheduled in a symbol that overlaps with an LTE CRS) based on CSI feedback and capability reporting from the UE. This dynamic indication may be done through any combination of RRC, MAC CE, or DCI signaling. When an NR PDCCH collides with an LTE CRS, the UE may monitor for the corresponding NR PDCCH candidate if the gNB has provided the dynamic indication that such a collision is enabled. If the gNB has not enabled the collision, the UE may not monitor the corresponding PDCCH candidate.

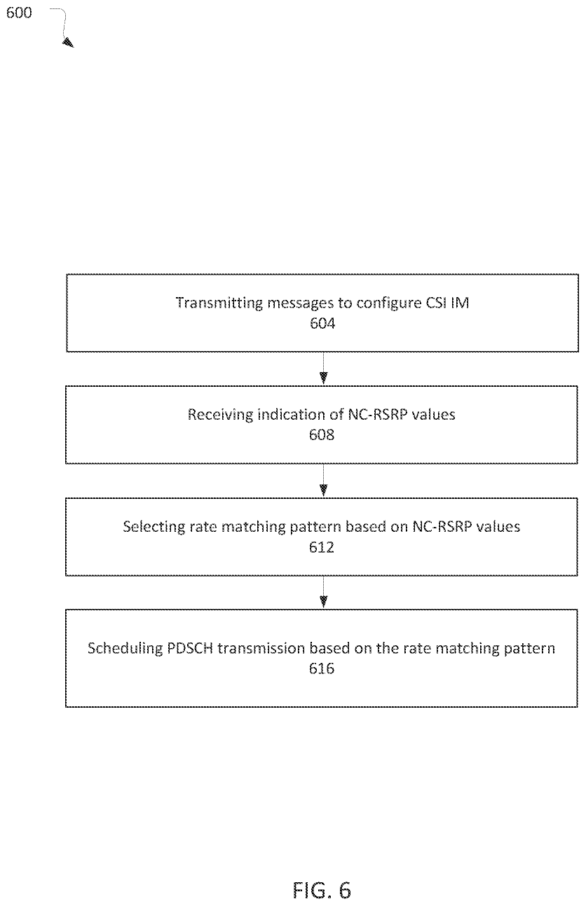

FIG. 6 illustrates an operation flow/algorithmic structure 600 in accordance with some aspects. The operation flow/algorithmic structure 600 may be performed or implemented by a gNB such as, for example, base station 108, gNB 308, 408, or 1000; or components thereof, for example, baseband processor 1004A.

The operation flow/algorithmic structure 600 may include, at 604, one or more messages to configure an interference measurement based on a CSI IMR that corresponds to an LTE reference signal. In some aspects, the one or more messages may be RRC messages to configure various measurement objects and reports. For example, the one or more RRC messages may configure IEs, such as CSI-IM-Resources, CSI-IM-ResourceSet, CSI-ResourceConfig, or CSI-ReportConfig as described herein.

In some aspects, the one or more messages transmitted at 604 may further include additional side information that may enable a receiving UE to reconstruct interfering LTE reference signals. This may allow the UE to reduce interference caused by such signals.

The operation flow/algorithmic structure 600 may further include, at 608, receiving an indication of NC-RSRP values. The NC-RSRP values may represent measurements that the UE performed on the CSI IMRs, which correspond to the interfering LTE reference signals. In some aspects, the NC-RSRP values may reflect the UE's ability to reduce interference caused by the LTE reference signals by reconstructing the LTE reference signals using the additional side information provided by the base station.

While aspects describe the UE feedback including NC-RSRP values, other aspects may include other measurements, such as, but not limited to, reference signal receive quality (RSRQ) values.

The operation flow/algorithmic structure 600 may further include, at 612, selecting a rate matching pattern based on the NC-RSRP values. In some aspects, the gNB may have previously configured the UE with a plurality of rate matching patterns. Then, at 612, the gNB may select which combinations of the rate matching patterns provide a desired spectral efficiency.

In some aspects, the gNB may estimate SIRs for individual resource elements based on the NC-RSRP values. These SIRs may be used to select the desired rate matching patterns.

The operation flow/algorithmic structure 600 may further include, at 616, scheduling a PDSCH transmission based on the rate matching patterns. The gNB may schedule the PDSCH transmission by transmitting a PDCCH to the UE. The gNB may also provide an indication of the selected rate matching patterns, either in the PDCCH or separately.

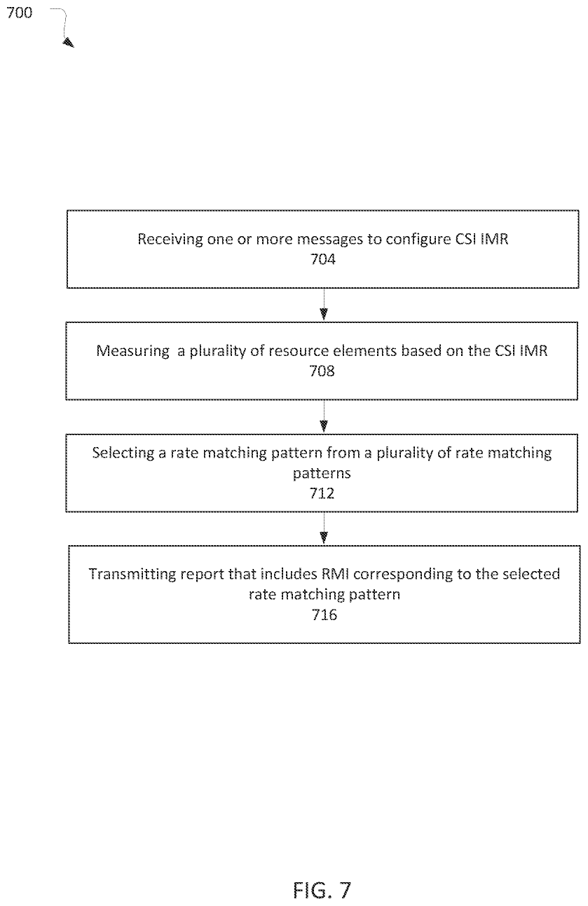

FIG. 7 illustrates an operation flow/algorithmic structure 700 in accordance with some aspects. The operation flow/algorithmic structure 700 may be performed or implemented by a UE such as, for example, UEs 104, 304, 404, or 900; or components thereof, for example, baseband processor 904A.

The operation flow/algorithmic structure 700 may include, at 704, receiving one or more messages to configure CSI IMR. Similar to above, the CSI IMR may correspond to a potentially interfering LTE reference signal. In some aspects, a plurality of CSI IMRs respectively corresponding to a plurality of potentially interfering LTE reference signals (from one or more neighbor LTE cells) may be received at 704. The UE may receive one or more RRC configuration (or reconfiguration) messages to configure the CSI IMRs.

The operation flow/algorithmic structure 700 may further include, at 708, measuring a plurality of resource elements based on the CSI IMR. The UE may measure energy on the resource elements indicated by the CSI IMR in order to determine a signal quality metric, such as, but not limited to, RSRP. In some aspects, the UE may further determine an SIR for the resource elements based on information corresponding to a desired signal (for example, an NZP signal) as a ratio to the interfering signal as measured RSRP. In some aspects, the measured RSRP may be reduced to the extent possible by a receiver of the UE canceling or mitigating interference from the LTE reference cells.

The operation flow/algorithmic structure 700 may further include, at 712, selecting a rate matching pattern from a plurality of rate matching patterns. In some aspects, the plurality of rate matching patterns that are available for selection may have been preconfigured by the gNB. The UE may determine which combinations of rate matching patterns increase a spectral efficiency as a function of SIRs of the resource elements. In some aspects, available RMIs may correspond to allowable combinations of rate matching patterns. The UE may then cycle through the available RMIs to select the desired RMI.

The operation flow/algorithmic structure 700 may further include, at 716, transmitting a report that includes an RMI corresponding to the selected rate matching pattern (or combination of patterns).

In some aspects, the report may include the RMI and one or more additional CSF metrics, such as, but not limited to, a CRI, RI, PMI, or CQI. These additional CSF metrics may be based on the RMI that is selected.

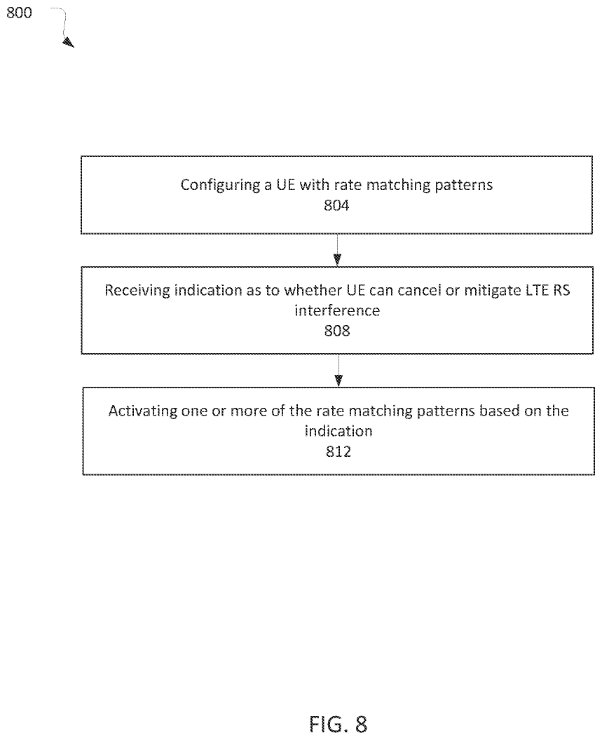

FIG. 8 illustrates an operation flow/algorithmic structure 800 in accordance with some aspects. The operation flow/algorithmic structure 800 may be performed or implemented by a gNB such as, for example, base stations 108, gNB 308, gNB 408, or gNB 1000; or components thereof, for example, baseband processor 1004A.

The operation flow/algorithmic structure 800 may include, at 804, configuring a UE with a plurality of rate matching patterns. In some aspects, the gNB may transmit one or more RRC signals to configure the rate matching patterns. For example, the gNB may send one or more RateMatchPatternLTE-CRS IEs to configure respective rate matching patterns.

The operation flow/algorithmic structure 800 may further include, at 808, receiving an indication as to whether the UE can cancel or mitigate LTE reference signal interference. The indication may be received independently from, as part of, or with requested feedback with respect to measurements on configured CSI IMRs.

The operation flow/algorithmic structure 800 may further include, at 812, activating one or more of the rate matching patterns based on the indication. The gNB may determine which of the rate matching patterns should be activated based on UE feedback. The UE feedback may indicate requested rate matching patterns or measurements (RSRP measurements). If the feedback is based on measurements, the gNB may estimate SIR based on the measurements and determine which rate matching patterns provide desired spectral efficiencies.

In some aspects, the indication of which rate matching pattern should be activated may be transmitted by MAC CE or DCI. For example, the activation signaling may reference the previously configured rate matching patterns with an indication of whether they should be activated or deactivated.

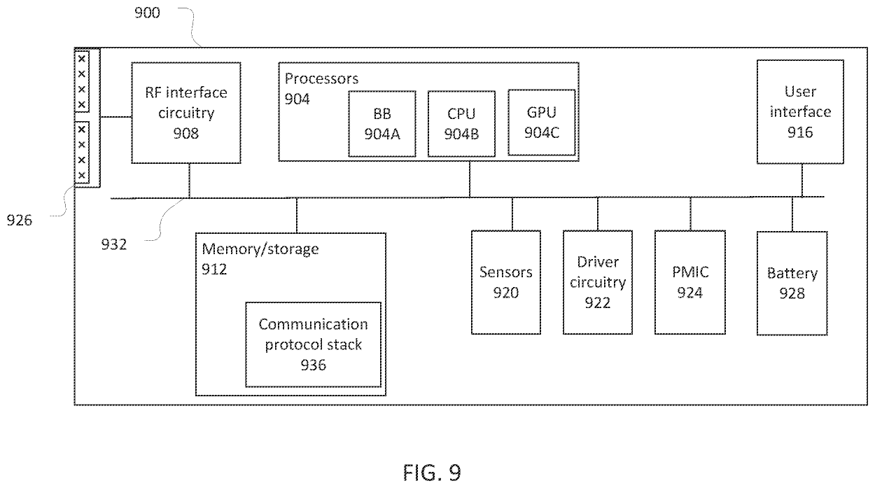

FIG. 9 illustrates a UE 900 in accordance with some aspects. The UE 900 may be similar to and substantially interchangeable with UEs 104, 304, or 404.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 900 may include processors 904, RF interface circuitry 908, memory/storage 912, user interface 916, sensors 920, driver circuitry 922, power management integrated circuit (PMIC) 924, antenna structure 926, and battery 928. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, optical connection, etc. that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein.

In some aspects, the baseband processor circuitry 904A may access a communication protocol stack 936 in the memory/storage 912 to communicate over a 3GPP compatible network. In general, the baseband processor circuitry 904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some aspects, the PHY layer operations may additionally/alternatively be performed by the components of the RF interface circuitry 908.

The baseband processor circuitry 904A may generate or process baseband signals or waveforms that carry information in 3GPP-compatible networks. In some aspects, the waveforms for NR may be based cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform various operations described herein. The memory/storage 912 may also store CSI IMR, reporting, and rate pattern configuration information as described elsewhere.

The memory/storage 912 include any type of volatile or non-volatile memory that may be distributed throughout the UE 900. In some aspects, some of the memory/storage 912 may be located on the processors 904 themselves (for example, L1 and L2 cache), while other memory/storage 912 is external to the processors 904 but accessible thereto via a memory interface. The memory/storage 912 may include any suitable volatile or non-volatile memory such as, but not limited to, dynamic random-access memory (DRAM), static random-access memory (SRAM), erasable programmable read-only memory (EPROM), electrically erasable programmable read only memory (EEPROM), Flash memory, solid-state memory, or any other type of memory device technology.

The RF interface circuitry 908 may include transceiver circuitry and radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various aspects, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple-input, multiple-output communications. The antenna 926 may include microstrip antennas, printed antennas fabricated on the surface of one or more printed circuit boards, patch antennas, phased array antennas, etc. The antenna 926 may have one or more panels designed for specific frequency bands including bands in FR1 or FR2.

The user interface circuitry 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 922 may include software and hardware elements that operate to control particular devices that are embedded in the UE 900, attached to the UE 1100, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensor circuitry 920 and control and allow access to sensor circuitry 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location, and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

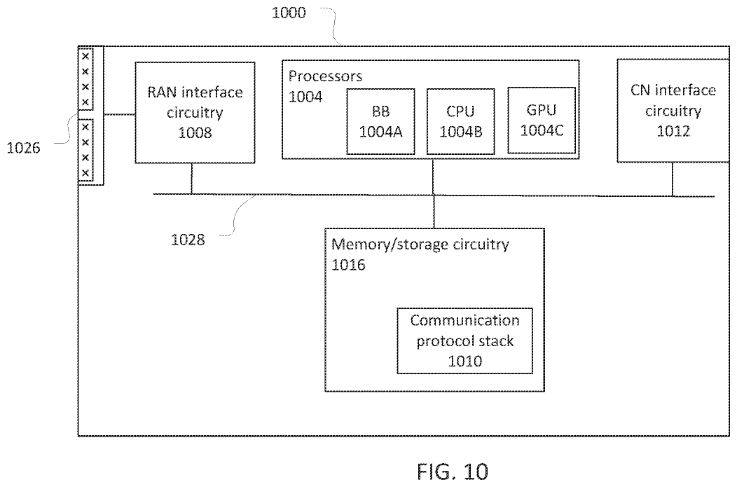

FIG. 10 illustrates a gNB 1000 in accordance with some aspects. The gNB node 1000 may similar to and substantially interchangeable with base station(s) 108, gNB 308, or gNB 408.

The gNB 1000 may include processors 1004, RF interface circuitry 1008, core network (CN) interface circuitry 1012, memory/storage circuitry 1016, and antenna structure 1026.

The components of the gNB 1000 may be coupled with various other components over one or more interconnects 1028.

The processors 1004, RF interface circuitry 1008, memory/storage circuitry 1016 (including communication protocol stack 1010), antenna structure 1026, and interconnects 1028 may be similar to like-named elements shown and described with respect to FIG. 9.

The CN interface circuitry 1012 may provide connectivity to a core network, for example, a 5^{th} Generation Core network (5GC) using a 5GC-compatible network interface protocol such as carrier Ethernet protocols, or some other suitable protocol. Network connectivity may be provided to/from the gNB 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some aspects, the gNB 1000 may be coupled with TRPs, such as TRPs 102 or 106, using the antenna structure 1026, CN interface circuitry 1012, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a base station, the method comprising: transmitting, to a user equipment (UE) in a new radio (NR) cell, one or more messages to configure an interference measurement based on a channel state information (CSI) interference measurement resource (IMR) that corresponds to a Long Term Evolution (LTE) reference signal; receiving, from the UE, an indication of one or more neighbor cell (NC)-reference signal receive power (RSRP) values that corresponds to the CSI IMR; selecting a rate matching pattern based on the one or more NC-RSRP values; and scheduling a physical downlink shared channel (PDSCH) transmission based on the rate matching pattern.

Example 2 includes the method of example 1 or some other example herein, wherein transmitting the one or more messages comprises: providing a CSI resource information element (IE) to configure the CSI IMR for measurement; and providing a CSI report IE that references the CSI resource IE to configure a report based on the CSI IMR.

Example 3 includes the method of example 2 or some other example herein, wherein the CSI resource IE is used to configure a CSI IMR set that includes a plurality of CSI IMRs including the CSI IMR wherein each of the plurality of CSI IMRs corresponds to a respective LTE reference signal.

Example 4 includes the method of example 1 or some other example herein, further comprising: transmitting, to the UE, information to reconstruct the reference signal, wherein the information includes a cell identifier of an LTE cell that transmits the LTE reference signal or an initialization seed for a scrambling sequence of the LTE reference signal.

Example 5 includes the method of example 1 or some other example herein, further comprising: estimating a signal-to-interference ratio (SIR) for one or more resource elements based on the one or more NC-RSRP values; and generating the rate matching pattern based on the SIR for the one or more resource elements.

Example 6 includes the method of example 1 or some other example herein, wherein the NC-RSRP value is a layer 1 value.

Example 7 includes the method of example 1 or some other example herein, further comprising: configuring the UE with a plurality of rate matching patterns for the NR cell, wherein the plurality is a number greater than six; selecting one or more rate matching patterns, including the rate matching pattern, from the plurality of rate matching patterns; and transmitting, to the UE, an indication of the one or more rate matching patterns selected.

Example 8 includes the method of example 1 or some other example herein, wherein the one or more messages are to configure two CSI IMRs to correspond to the LTE reference signal and account for a DC carrier punctured with respect to the LTE reference signal; or are to configure the CSI IMR by including an LTE cell reference signal (CRS) pattern information element that corresponds to the LTE reference signal.

Example 9 includes a method of operating a user equipment (UE), the method comprising: receiving, from a gNB, one or more messages to configure an interference measurement based on an channel state information (CSI) interference measurement resource (IMR) resource that corresponds to a Long Term Evolution (LTE) reference signal; measuring a plurality of resource elements based on the CSI IMR; selecting one or more rate matching patterns from a plurality of rate matching patterns based on said measuring of the plurality of resource elements; and transmitting, to the gNB, a report that includes a rate matching indicator (RMI) that corresponds to the one or more rate matching patterns.

Example 10 includes the method of example 9 or some other example herein, wherein the one or more messages are to provide: a CSI resource information element (TE) to configure the CSI IMR; and a CSI report IE that references the CSI resource IE to configure a report based on the CSI IMR.

Example 11 includes the method of example 11 or some other example herein, wherein the CSI resource IE is to configure a CSI IMR set that includes a plurality of CSI IMRs including the CSI IMR, wherein each of the plurality of CSI IMRs corresponds to a respective LTE reference signal.

Example 12 includes the method of example 9 or some other example herein, further comprising: receiving, from the gNB, additional information that includes a cell identifier of an LTE cell that transmits the LTE reference signal or an initialization seed for a scrambling sequence of the LTE reference signal; determining the UE is able to cancel or mitigate interference caused by the LTE reference with respect to at least one resource element by reconstructing the LTE reference signal based on the additional information; and selecting the one or more rate matching patterns based on said determining the UE is able to cancel or mitigate the interference.

Example 13 includes the method of example 9 or some other example herein, wherein the RMI comprises or corresponds to a bit mask to identify resource elements around which a physical downlink shared channel is requested to be rate matched.

Example 14 includes the method of example 13 or some other example herein, further comprising: determining, based on the RMI, one or more reporting indicators that include a channel state information reference signal resource indicator, rank indicator, a precoding matrix indicator, or a channel quality indicator; and including the one or more indicators in the report.

Example 15 includes the method of example 9 or some other example herein, wherein the one or more messages are to configure a plurality of CSI IMRs corresponding to a respective plurality of LTE reference signals and the method further comprises: estimating, for each of a plurality of RMIs, an associated spectral efficiency; and selecting the RMI from the plurality of RMIs that is associated with a relatively highest estimated spectral efficiency.

Example 16 includes the method of example 15 or some other example herein, wherein estimating the associated spectral efficiency for the RMI comprises: determining, for each of a plurality of LTE reference signals, a component based on estimated spectral efficiency as a function of a signal and interference to be caused by a respective LTE reference signal multiplied by an expected portion of resource elements that would experience the interference from the respective LTE reference signal for a transmission using the one or more rate matching patterns associated with the RMI.

Example 17 includes a method of operating a base station, the method comprising: configuring a user equipment (UE) that is connected to a New Radio (NR) cell with a plurality of rate matching patterns using radio resource control (RRC) signaling; receiving, from the UE, an indication that the UE can cancel or mitigate interference associated with one or more Long-Term Evolution (LTE) reference signals (RSs); and activating one or more rate matching patterns from the plurality of rate matching patterns based on the indication that the UE can cancel or mitigate the interference.

Example 18 includes the method of example 17 or some other example herein, wherein activating the one or more rate matching patterns comprises: transmitting a media access control (MAC)-control element (CE) or downlink control information to identify the activated one or more rate matching patterns.

Example 19 includes the method of example 17 or some other example herein, further comprising: rate matching a physical downlink shared channel (PDSCH) transmission around at least some resource elements based on the activated one or more rate matching patterns.

Example 20 includes a method of operating a base station, the method comprises: receiving a capability indication from a user equipment (UE) that is connected to a New Radio (NR) cell, the capability indication to indicate whether the UE supports scheduling of an NR physical downlink control channel (PDCCH) on a symbol that overlaps with a symbol upon which a Long-Term Evolution (LTE) cell reference signal (CRS) is to be transmitted in an LTE cell; configuring the NR PDCCH based on the capability indication.

Example 21 includes the method of example 20 or some other example herein, further comprising: receiving, from the UE, an indication that the UE can cancel or mitigate interference caused by one or more LTE reference signals (RSs); and transmitting, to the UE, an indication of whether the NR PDCCH is to be transmitted on a symbol that overlaps with the symbol upon which the LTE CRS is to be transmitted.

Example 22 includes the method of example 21 or some other example herein, wherein transmitting the indication using radio resource control (RRC) signaling, media access control (MAC)-control element (CE), or downlink control information (DCI).

Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, information element, packet, frame, segment, PDU, or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, IE, packet, frame, segment, PDU, or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-21. (canceled)

22. A method of operating a base station, the method comprising:
transmitting, to a user equipment (UE) in a cell of a first radio access technology (RAT), one or more messages to configure an interference measurement based on a channel state information (CSI) interference measurement resource (IMR) that corresponds to a reference signal of a second RAT;
receiving, from the UE, an indication of one or more neighbor cell (NC)-reference signal receive power (RSRP) values that corresponds to the CSI IMR;
selecting a rate matching pattern based on the one or more NC-RSRP values; and
scheduling a physical downlink shared channel (PDSCH) transmission based on the rate matching pattern.

23. The method of claim 22, wherein transmitting the one or more messages comprises:
providing a CSI resource information element (IE) to configure the CSI IMR for measurement; and
providing a CSI report IE that references the CSI resource IE to configure a report based on the CSI IMR.

24. The method of claim 23, wherein the CSI resource IE is used to configure a CSI IMR set that includes a plurality of CSI IMRs including the CSI IMR, wherein each of the plurality of CSI IMRs corresponds to a respective reference signal of the second RAT.

25. The method of claim 22, further comprising:
transmitting, to the UE, information to reconstruct the reference signal, wherein the information includes a cell identifier of a cell of the second RAT that transmits the reference signal or an initialization seed for a scrambling sequence of the reference signal.

26. The method of claim 22, further comprising:
estimating a signal-to-interference ratio (SIR) for one or more resource elements based on the one or more NC-RSRP values; and
generating the rate matching pattern based on the SIR for the one or more resource elements.

27. The method of claim 22, wherein the one or more NC-RSRP values comprises a layer-1 value.

28. The method of claim 22, further comprising:
configuring the UE with a plurality of rate matching patterns for the cell of the first RAT, wherein the plurality is a number greater than six;
selecting one or more rate matching patterns, including the rate matching pattern, from the plurality of rate matching patterns; and
transmitting, to the UE, an indication of the one or more rate matching patterns selected.

29. The method of claim 22, wherein the one or more messages are to configure two CSI IMRs to correspond to the reference signal and account for a DC carrier punctured with respect to the reference signal; or are to configure the CSI IMR by including a cell reference signal (CRS) pattern information element that corresponds to the reference signal.

30. One or more non-transitory, computer-readable media having instructions that, when executed by one or more processors, cause a user equipment (UE) to:
receive, from a base station, one or more messages to configure an interference measurement based on an channel state information (CSI) interference measurement resource (IMR) resource that corresponds to a reference signal of a first radio access technology (RAT);
measure a plurality of resource elements based on the CSI IMR
select one or more rate matching patterns from a plurality of rate matching patterns based on said measuring of the plurality of resource elements; and
transmit, to the base station, a report that includes a rate matching indicator (RMI) that corresponds to the one or more rate matching patterns.

31. The one or more non-transitory, computer-readable media of claim 30, wherein the one or more messages are to provide:
a CSI resource information element (IE) to configure the CSI IMR; and
a CSI report IE that references the CSI resource IE to configure a report based on the CSI IMR.

32. The one or more non-transitory, computer-readable media of claim 31, wherein the CSI resource IE is to configure a CSI IMR set that includes a plurality of CSI IMRs including the CSI IMR, wherein each of the plurality of CSI IMRs corresponds to a respective reference signal of the first RAT.

33. The one or more non-transitory, computer-readable media of claim 30, wherein the instructions, when executed, further cause the UE to:
receive, from the base station, additional information that includes a cell identifier of a cell of the first RAT that transmits the reference signal or an initialization seed for a scrambling sequence of the reference signal of the first RAT;
determine the UE is able to cancel or mitigate interference caused by the reference signal of the first RAT with respect to at least one resource element by reconstructing the reference signal of the first RAT based on the additional information; and
select the one or more rate matching patterns based on said determination the UE is able to cancel or mitigate the interference.

34. The one or more non-transitory, computer-readable media of claim 30, wherein the RMI comprises or corresponds to a bit mask to identify resource elements around which a physical downlink shared channel is requested to be rate matched.

35. The one or more non-transitory, computer-readable media of claim 34, wherein the instructions, when executed, further cause the UE to:
determine, based on the RMI, one or more reporting indicators that include a channel state information reference signal resource indicator, rank indicator, a precoding matrix indicator, or a channel quality indicator; and
include the one or more reporting indicators in the report.

36. The one or more non-transitory, computer-readable media of claim 30, wherein the one or more messages are to configure a plurality of CSI IMRs corresponding to a respective plurality of reference signals of the first RAT and the instructions, when executed, further cause the UE to:
estimate, for each of a plurality of RMIs, an associated spectral efficiency.

37. The one or more non-transitory, computer-readable media of claim 36, wherein the instructions, when executed, further cause the UE to:
select the RMI from the plurality of RMIs that is associated with a relatively highest estimated spectral efficiency.

38. The one or more non-transitory, computer-readable media of claim 37, wherein to estimate the associated spectral efficiency for the RMI the UE is to:
determine, for each of a plurality of reference signals of the first RAT, a component based on estimated spectral efficiency as a function of a signal and interference to be caused by a respective reference signal of the first RAT multiplied by an expected portion of resource elements that would experience the interference from the respective reference signal of the first RAT for a transmission using the one or more rate matching patterns associated with the RMI.

39. An apparatus to be implemented in a base station, the apparatus comprising:
memory to store rate pattern configuration information; and
processing circuitry, coupled with the memory, the processing circuitry to:
configure, based on the rate pattern configuration information, a user equipment (UE) that is connected to a cell of a first radio access technology (RAT) with a plurality of rate matching patterns using radio resource control (RRC) signaling;
receive, from the UE, an indication that the UE can cancel or mitigate interference associated with one or more reference signals (RSs) of a second RAT; and
activate one or more rate matching patterns from the plurality of rate matching patterns based on the indication that the UE can cancel or mitigate the interference.

40. The apparatus of claim 39, wherein to activate the one or more rate matching patterns the processing circuitry is to:
transmit a media access control (MAC)-control element (CE) or downlink control information to identify the activated one or more rate matching patterns.

41. The apparatus of claim 39, wherein the processing circuitry is further to:
rate match a physical downlink shared channel (PDSCH) transmission around at least some resource elements based on the activated one or more rate matching patterns.
